(19) United States
(12) Patent Application Publication
(10) Pub. No.: US 2002/0132645 A1
(43) Pub. Date: Sep. 19, 2002

(54) Mobile terminal with schedule display

(76) Inventor: Stephen A. Sprigg, Poway, CA (US)

Correspondence Address: Qualcomm Incorporated, Patents Department, 5775 Morehouse Drive, San Diego, CA, 92121-1714, US

(21) Appl. No.: 09/768,892

(22) Filed: Jan. 24, 2001

(51) Int. Cl. H04M 1/00

(52) U.S. Cl. 455/566; 455/550; 455/414

(57) ABSTRACT

A mobile communications terminal having a display, a processor, memory, a user input device and a time reference is described. The processor executes a schedule program which allows times and/or dates of events to be input and displayed to the user. The processor derives the current date and/or day from the time reference and displays information relating to the stored events, dependent on the current date and/or day.

### BACKGROUND OF THE INVENTION

The present invention relates to a mobile communications terminal including a schedule display function.

Mobile communications terminals are commonly provided as an integrated unit comprising a keypad, microphone, earpiece and display. The display is used to display the number dialed, the status and settings of the terminal, and stored data such as telephone numbers which can be recalled and used in the communications functions of the mobile terminal.

The document WO 97/29582 discloses a mobile telephone having a user interface which displays different function labels and a moveable indicator which can be manipulated by the user, by means of a track ball, so as to select the desired function.

Other functions such as simple games have been provided in mobile terminals. However, their functionality is limited by the small size of the display, which is typically a liquid crystal display of no more than 96 by 64 pixels.

Personal Digital Assistants (PDA's) provide much larger graphical displays but are not small enough to be carried by a user at all times, and do not have an integrated communications terminal; instead, a discrete terminal must be connected to the PDA if communications functionality is required. Some examples of PDA's with integrated mobile phones exist, such as the Nokia™ 9110 Communicator, but these are typically large and expensive.

Hence, a problem exists in providing useful applications on the small displays usually provided on mobile telephones.

### SUMMARY OF THE INVENTION

According to the present invention, there is provided a mobile communications terminal having a display, a processor, memory, a user input device and a time reference. The processor executes a schedule program which allows times and/or dates of events to be input and displayed to the user. The processor derives the current date and/or day from the time reference and displays information relating to the stored events, dependent on the current date and/or day.

In one preferred embodiment, the information relates to a subset of the events for the current date, selected according to the current time of day. Preferably, the displayed events scroll on the display as time passes and the current time changes.

In another preferred embodiment, the displayed information represents the duration of an event by a displayed element and, if the recorded time of the event includes the current time, indicates the current time by a variable position or size of an indicator relative to the displayed element.

### BRIEF DESCRIPTION OF THE DRAWINGS

FIG. 1 is a diagram of a mobile terminal in an embodiment of the present invention;

FIG. 2 is a schematic diagram of the functional components of the mobile terminal;

FIG. 3 is an example of a display of a schedule application in an embodiment of the present invention;

FIG. 4 is an example of a display of the schedule application at a later time on the same day;

FIG. 5 is a flowchart of a daily schedule display procedure in the embodiment; and

FIG. 6 is a flowchart of a current time indicator display procedure in the embodiment.

### DETAILED DESCRIPTION OF THE PREFERRED EMBODIMENTS

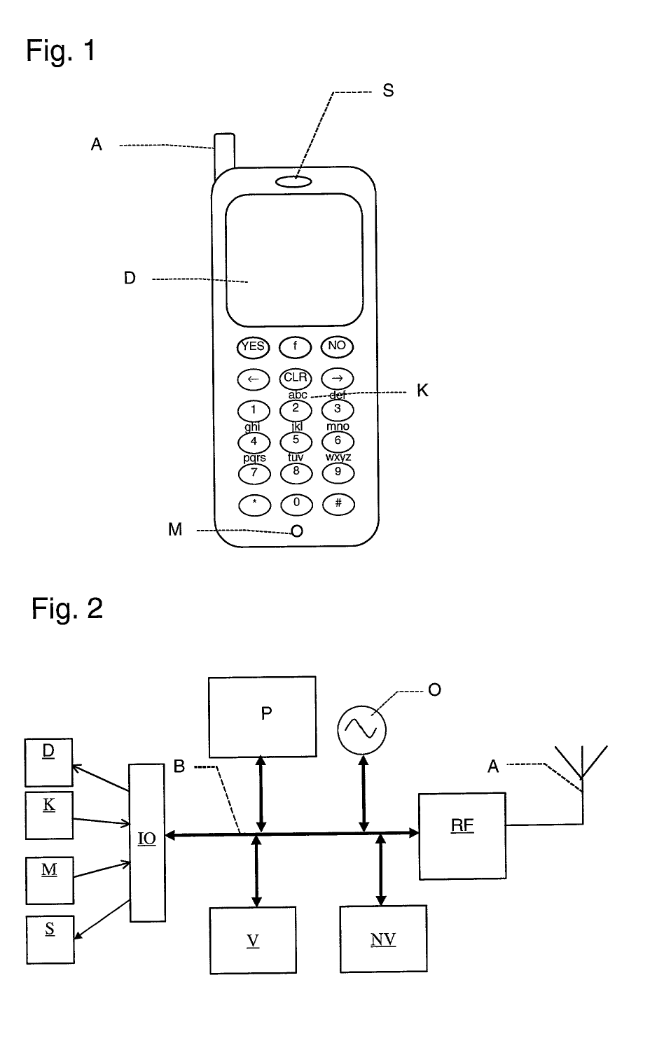

FIG. 1 shows a mobile telephone handset H having a keypad K comprising numeric keys 0 to 9, star (★) and hash (#) keys, and function keys such as ‘YES’, ‘NO’, back/up (←), forward/down (→), clear (CLR) and other function (f). A display D is an LCD with sufficient resolution to display at least several lines of characters. A microphone M and speaker S are also present, to allow voice calls.

FIG. 2 is a schematic diagram of the electronic components of the handset H. These components need not be discrete, and may be integrated. For example, the components may be integrated onto a microcontroller chip and an RF stage chip. A processor P is connected via a bus B to a volatile memory (V), a non-volatile memory (NV), an I/O interface (I/O) and an RF modem (RF). The I/O interface decodes input from the keypad K and microphone M, and drives the display D and speaker S. The RF modem is connected to an antenna A so as to receive and transmit RF signals. The components are powered by a battery (not shown) or a mains electricity connection (not shown) via a transformer. A local oscillator O provides a time reference so as to record the current time, even when the display D and other functions are powered down. The handset may receive time reference radio signals which are used to synchronize the local oscillator O to a network time reference.

The non-volatile memory (NV) stores software which is executed by the processor P in order to carry out the functions of the handset and any applications which are to be run on the handset. Optionally, the non-volatile memory is reprogrammable to upgrade the software. The upgrade may be received as a wireless message, via the RF modem (RF). The non-volatile memory may include a removable component which can be transferred to other handsets H, such as a SIM card.

The handset H implements protocols which allow text messages to be sent and received. For example, the handset may be GSM-compatible and support the GSM SMS (short message service) protocols.

A schedule application allows the user to enter, store, view and edit a database of appointments, in the form of text entries each associated with a date and/or time range. For example, the user may key in the text ‘Meeting Qualcomm’ using the keypad K to enter characters by any known technique, such as selecting a character by multiple presses of the same key, or by predictive input. When the ‘Yes’ key is pressed, the application then prompts the user to enter the start and end times of the appointment, in this case 10:00 to 12:30, on Oct. 2, 2000.

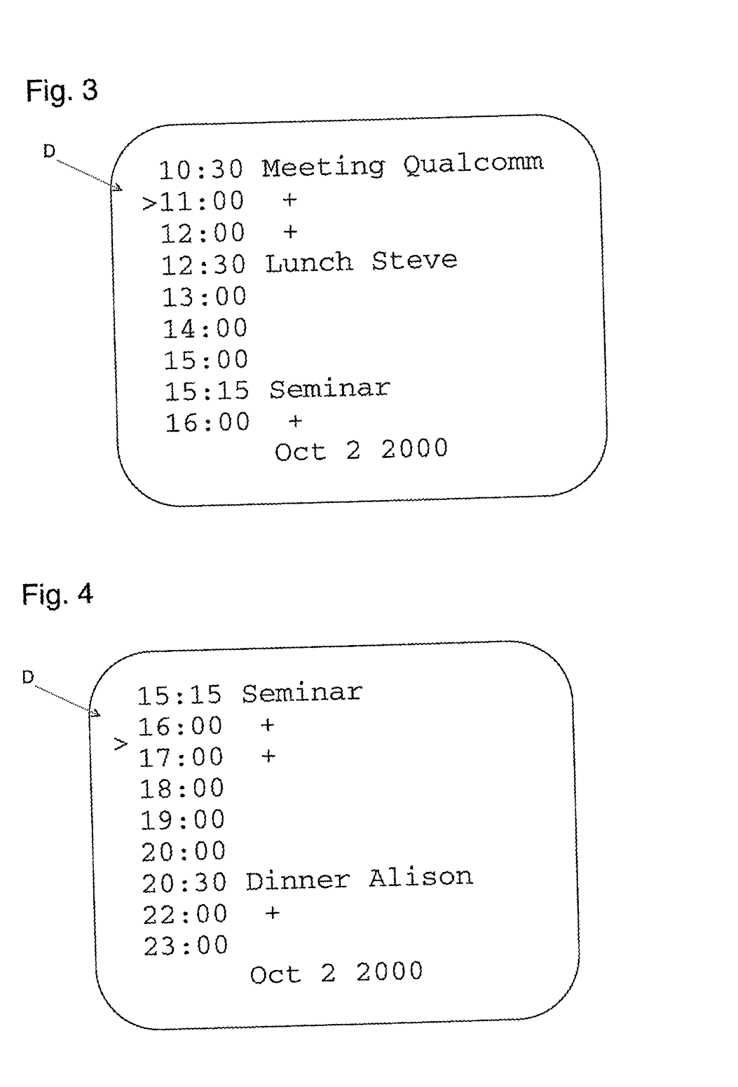

The schedule application is operable in any one of a number of different display modes. The display mode shown in FIG. 3 is a daily schedule display in which the date is shown on a status line S and the remaining lines show the times of schedule entries for that day. The exact start time of each entry is shown, together with intervening hours, as illustrated in FIG. 3.

The display D allows only 10 lines of characters to be displayed and it is therefore not possible simultaneously to show all of the appointments for the current day. In accordance with an embodiment of the present invention, the processor P provides an automatic scrolling of the characters shown on the display so that an appointment or time corresponding to the current time of day remains in view as the time of day progresses. The current time of day is indicated by an arrow ‘>’ to the left of the time column in the display; hence, FIG. 3 shows the daily schedule display at 11 am. FIG. 4 shows the daily schedule display at 4:30 pm on the same day: the display has scrolled so as to keep the current appointment in view, while showing later appointments for which space is available on the display D. As the current time is intermediate the displayed times ‘16:00’ and ‘117:00’, the arrow ‘>’ is positioned between these two displayed times. Hence, it is an additional advantageous feature of the display that the current time does not need to be displayed explicitly in characters; instead, the current time is indicated by moving the arrow relative to the displayed times of appointments or empty slots.

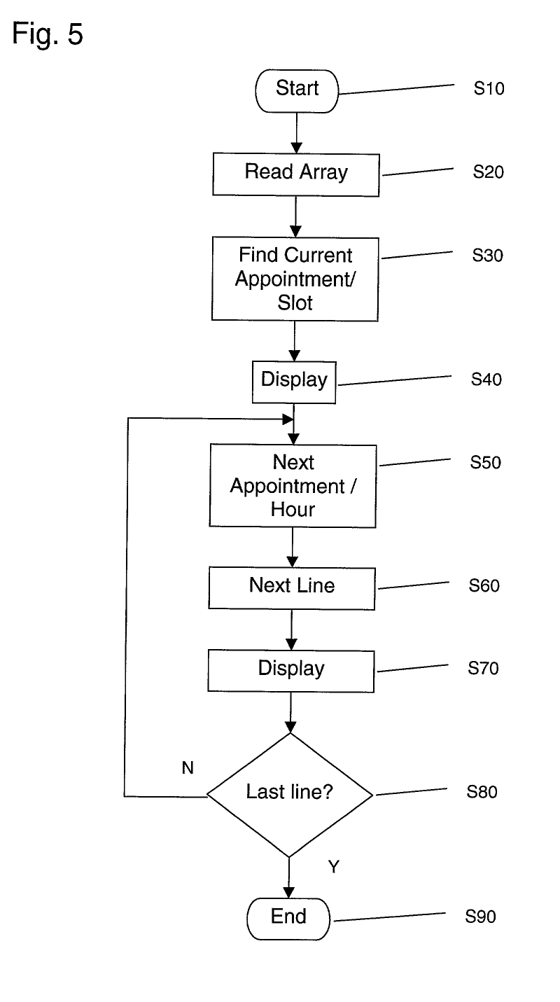

FIG. 5 is a flowchart of the procedure executed by the processor P in controlling the display so as to scroll automatically, in accordance with the time of day stored by the local oscillator O. The procedure may be run (S10) every hour, or the time for running the procedure may be set as the end time of the current appointment. The processor P reads (S20) an array of the schedule for the current day, as shown for example in Table 1 below:

TABLE 1
Daily Schedule Array

| Index | Date | Start | End | Text |
|---|---|---|---|---|
| 1 | 10/2/00 | 10:30 | 12:30 | Meeting Qualcomm |
| 2 | 10/2/00 | 12:30 | 13:30 | Lunch Steve |
| 3 | 10/2/00 | 15:15 | 17:30 | Seminar |
| 4 | 10/2/00 | 20:30 | 22:30 | Dinner Alison |

If the current time lies within an appointment in the schedule (S30), the text and start time of that appointment is displayed (S40) on the first line of the display. Otherwise, the hourly slot within which the current time falls is displayed (S40). Hours are displayed on successive lines until the start of the next appointment, where the start time and text of the appointment is displayed (S50-S70). For any hour at which an appointment continues, a ‘+’ symbol is displayed. The procedure continues until the last line available to the daily schedule is displayed (S 80), at which point the procedure ends (S 90).

The current date is displayed on a status line, unless this feature is disabled by the user, in which case an additional schedule line is displayed instead. By default, the end time is not displayed, but is used by the schedule application to prevent overlapping appointments being entered.

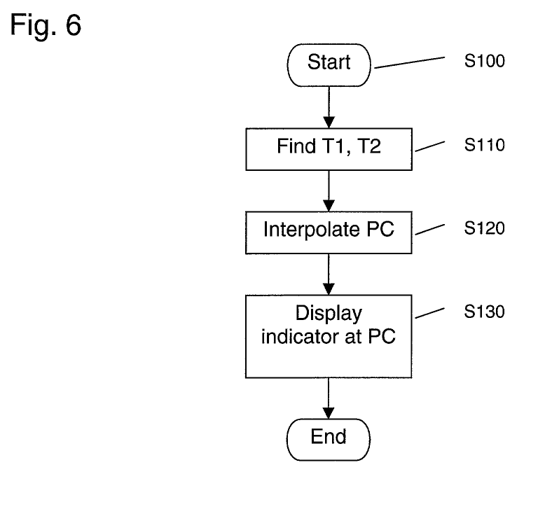

The procedure for positioning the arrow to indicate the approximate time will now be described with reference to FIG. 6. The procedure may be run (S100) every minute, for example. The arrow is positioned by determining (S110) between which two adjacent displayed times the current time falls. The position of the arrow is then interpolated (S120) between the mid-lines of these two displayed times, the arrow is displayed (S130) and the procedure ends (S140).

For example, if the two displayed times are T1 and T2, the current time is C, the number of pixel lines between character lines is NP and the pixel line position of the earlier of the two times is P1, the pixel line position PC of the tip of the arrow is given by:

$$P C = P1 + \frac{( C - T1 )}{( T2 - T1 )} \times N P \qquad ( 1 )$$

The position of the arrow therefore gives an approximate indication of the current time relative to the daily schedule, without requiring a separate time display.

In an alternative embodiment, the pixel line position PC may be displayed in reverse video, so that space is not required for an arrow or other indicator character.

In another alternative, the pixel columns of the character lines relating to the current appointment (or the current hourly blank slot if there is no current appointment) are progressively changed from left to right to reverse video in proportion to the fraction of the appointment period (or hour) which has elapsed.

The user may manually scroll through the daily schedule display using the back/up (←) and forward/down (→) keys, but the display returns to the automatic scrolling function after a predetermined time from the last key press, or by the user pressing the Clear key (CLR).

The schedule program, or a schedule display program enabling the above embodiment to be performed, may be recorded on a carrier, such as a radio-frequency signal receivable by the handset H or removable media readable directly by the handset H or indirectly via a connection to a computer.

The above embodiment is described purely by way of example; various alternative embodiments may be envisaged, which nevertheless fall within the spirit and scope of the present invention.

What we claim is:

1. A mobile communications terminal, comprising:
a storage for storing a database of schedule data including data relating to time of day;
a display for displaying selected information from said database, the display communicatively coupled to the storage; and
a time reference for providing current time of day information, wherein the displayed selected information is variable dependent on the current time of day information.

2. The terminal according to claim 1, wherein the selected information is displayed as a sequential list that scrolls as the current time of day information changes.

3. The terminal according to claim 1, wherein the display is arranged to indicate which of the displayed selected information corresponds to the current time of day information.

4. The terminal according to claim 1, further comprising a user input device arranged to allow input of said schedule data.

5. A mobile communications terminal, comprising:
a memory storing a database of schedule data including data relating to time of day;
a display communicatively connected to the memory and used for displaying at least some of said schedule data and a time of day indicator;
a digital signal processing device providing current time of day information, wherein said time of day indicator is associated on the display with an item of said displayed schedule data coincident with said current time of day information.

6. The terminal according to claim 4, wherein the position of said time of day indicator relative to said item of said displayed schedule data is variable in accordance with the current time of day information and the duration of said item of said displayed schedule data.

7. A method of displaying schedule data relating to time of day on a mobile communications terminal, comprising:
storing a database of schedule data including data relating to time of day;
reading current time of day information;
selecting information from said database according to said current time of day information; and
displaying said selected information.

8. The method according to claim 7, wherein the selected information is displayed as a sequential list which scrolls as the current time of day information changes.

9. The method according to claim 7, wherein the display indicates which of the displayed selected information corresponds to the current time of day information.

10. The method according to claim 7, including receiving said schedule data as input from a user input device.

11. The computer program arranged to perform the method of claim 7 when executed on a programmable mobile terminal.

12. The method of displaying schedule data relating to time of day on a mobile communications terminal, including:
a. storing a database of schedule data including data relating to time of day;
b. reading current time of day information; and
c. displaying at least some of said schedule data and a time of day indicator associated with an item of said displayed schedule data coincident with the current time of day information.

13. The method according to claim 11, wherein the position of the time of day indicator relative to said item of said displayed schedule data is variable in accordance with the current time of day information and the duration of said item of said displayed schedule data.

14. The computer program arranged to perform the method of claim 11 when executed on a programmable mobile terminal.

15. A computer program according to claim 13, recorded on a carrier.
